(19) United States
(12) Patent Application Publication
(10) Pub. No.: US 2023/0257680 A1
(43) Pub. Date: Aug. 17, 2023

(54) CLEANING PRODUCT

(71) Applicant: The Procter & Gamble Company, Cincinnati, OH (US)

(72) Inventor: Alice Michele BOUTOILLE, BRUSSELS (BE)

(21) Appl. No.: 18/105,358

(22) Filed: Feb. 3, 2023

(30) Foreign Application Priority Data
Feb. 11, 2022 (EP) 22156233.3

(51) Int. Cl. C11D 1/94; C11D 17/00; C11D 3/20; C11D 3/43

(52) U.S. Cl. CPC C11D 1/94; C11D 17/0043; C11D 3/201; C11D 3/2068; C11D 3/43; C11D 1/662

(57) ABSTRACT

The present disclosure relates to a cleaning product comprising a spray dispenser and a cleaning composition housed in the spray dispenser, where the cleaning composition comprises an alkyl polyglucoside surfactant, a surfactant selected from amphoteric surfactant, zwitterionic surfactant, and mixtures thereof, and one or more quaternary ammonium surfactants, and where the product provides good initial and sustained sudsing during the wash, as well as improved rinsing.

### FIELD OF INVENTION

The present disclosure relates to a cleaning product comprising a spray dispenser and a cleaning composition housed in the spray dispenser, where the cleaning composition comprises an alkyl polyglucoside surfactant, a surfactant selected from amphoteric surfactant, zwitterionic surfactant, and mixtures thereof, and one or more quaternary ammonium surfactants and where the product provides good initial and sustained sudsing during the wash, as well as improved rinsing.

### BACKGROUND OF THE INVENTION

Traditionally manual dishwashing has been performed by filling a sink with water, adding a dishwashing detergent to create a soapy solution, immersing the soiled articles in the solution, scrubbing the articles and rinsing to remove the remaining soils and remove the suds generated from the soapy solution from the washed articles. Traditionally an entire load of soiled dishware has usually been washed in one go. Nowadays some users prefer to clean articles as soon as they have finished with them rather than wait until they have a full load. This involves washing one article or a small number of articles at the time. The washing is usually performed under running water rather than in a full sink. The cleaning should be fast and involve minimum effort from the user. In such washing under the tap, the user typically delivers detergent to a sponge. This has the disadvantage of often dosing more detergent than is actually needed, especially when there are only a few items to be washed. Moreover, excessive amounts of detergent require more water and more time to rinse.

The use of a cleaning product comprising a spray dispenser and a cleaning composition alleviates such problems. However, it remains challenging to formulate a cleaning composition for a spray product which provides both good initial sudsing after spraying and sustained sudsing during the wash, as well as easy rinsing of the generated suds, thereby reducing rinse time and water consumption. Initial sudsing, often referred to as “flash” sudsing, is important to give users the connotation of good cleaning efficacy.

Hence, a need remains for a cleaning product comprising a spray dispenser and a cleaning composition, which provides good initial and sustained sudsing during the wash, as well as improved rinsing, thereby reducing rinse time and water consumption.

### SUMMARY OF THE INVENTION

The present invention relates to a cleaning product comprising a spray dispenser and a cleaning composition housed in the spray dispenser, the cleaning composition comprising from about 0.1% to about 15% by weight of the composition of one or more surfactants comprising: i. alkyl polyglucoside, ii. a surfactant selected from the group consisting of amphoteric surfactants, zwitterionic surfactants, and mixtures thereof, and iii. a quaternary ammonium surfactant, where the alkyl polyglucoside and the surfactant selected from group consisting of amphoteric surfactants, zwitterionic surfactants, and mixtures thereof are present in a weight ratio of from about 10:1 to about 1:10 and where the cleaning composition comprises less than about 3%, preferably less than about 2%, more preferably less than about 1% by weight of the cleaning composition of anionic surfactant.

The present invention further relates to a method of cleaning soiled dishware using the product according to the invention comprising the steps of: optionally pre-wetting the soiled dishware; spraying the cleaning composition onto the soiled dishware; optionally scrubbing the dishware; and rinsing the dishware.

### DETAILED DESCRIPTION OF THE INVENTION

Features and benefits of the various embodiments of the present invention will become apparent from the following description, which includes examples of specific embodiments intended to give a broad representation of the invention. Various modifications will be apparent to those skilled in the art from this description and from practice of the invention. The scope is not intended to be limited to the particular forms disclosed and the invention covers all modifications, equivalents, and alternatives falling within the spirit and scope of the invention as defined by the claims.

As used herein, articles such as “a” and “an” when used in a claim, are understood to mean one or more of what is claimed or described.

As used herein, the terms “include”, “includes” and “including” are meant to be non-limiting.

The term “dishware” as used herein encompasses implements and items used to cook, serve, and eat food. Dishware includes cookware and tableware made from, by nonlimiting examples, ceramic, china, metal, glass, plastic (e.g., polyethylene, polypropylene, polystyrene, etc.) and wood.

The term “spray dispenser” as used herein refers to a container comprising a housing to accommodate a cleaning composition and a mechanism to spray the cleaning composition, such as a trigger spray. The cleaning composition preferably foams when it is sprayed on a surface to be treated. The terms “suds/sudsing” and “foam/foaming” are used interchangeably.

The term “sudsing profile” as used herein refers to the properties of a cleaning composition relating to suds character during the dishwashing process. The term “sudsing profile” of a cleaning composition includes initial suds volume generated upon spraying of the cleaning composition and the retention of the suds during the dishwashing process. Preferably, hand dishwashing cleaning compositions characterized as having “good sudsing profile” tend to have high suds volume and/or sustained suds volume, particularly during a substantial portion of or for the entire manual dishwashing process. This is important as the consumer uses high suds as an indicator that sufficient cleaning composition has been dosed. Moreover, the consumer also uses the sustained suds volume as an indicator that sufficient active cleaning ingredients (e.g., surfactants) are present, even towards the end of the dishwashing process. The consumer usually re-sprays the cleaning composition when the sudsing subsides. Thus, a low sudsing cleaning composition may be replaced by the consumer more frequently than necessary, because of the low sudsing level.

The term “substantially free of” or “substantially free from” as used herein refers to either the complete absence of an ingredient or a minimal amount thereof merely as impurity or unintended by-product of another ingredient. A composition that is “substantially free” of/from a component means that the composition comprises less than about 0.5%, less than about 0.25%, less than about 0.1%, less than about 0.05%, or less than about 0.01% by weight of the composition, of the component.

Unless otherwise noted, all component or composition levels are in reference to the active portion of that component or composition, and are exclusive of impurities, for example, residual solvents or by-products, which may be present in commercially available sources of such components or compositions.

All percentages and ratios are calculated by weight unless otherwise indicated. All percentages and ratios are calculated based on the total composition unless otherwise indicated. It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

Cleaning Product

The present disclosure relates to a cleaning product, particularly a hand dishwashing cleaning product, that comprises a spray dispenser and a cleaning composition housed in the spray dispenser. The need for a cleaning product comprising a spray dispenser and a cleaning composition that provides good initial and sustained sudsing during the wash, as well as easy rinsing (thereby reducing rinse time and water consumption), may be met by a cleaning product comprising a spray dispenser and a cleaning composition housed in the spray dispenser, where the cleaning composition comprises surfactant, the surfactant comprising alkyl polyglucoside, a surfactant selected from the group consisting of amphoteric surfactants, zwitterionic surfactants, and mixtures thereof, and a quaternary ammonium surfactant. Such cleaning products have also been found to provide an improved rinsing profile, particularly by reducing overall wash time and water consumption.

More specifically, the use of a cleaning composition comprising a combination of alkyl polyglucoside and a surfactant selected from the group consisting of amphoteric surfactants, zwitterionic surfactants, and mixtures thereof, in the spray dispenser, has been found to provide good initial sudsing. Additionally, it is believed that reducing the amount of anionic surfactant in the cleaning composition (the cleaning composition preferably being substantially free of anionic surfactant) may further improve initial sudsing. Without being bound by theory, it is believed that anionic surfactant favours the formation of strong surfactant micelles, thereby inhibiting initial suds formation. Surprisingly, it has also been found that the addition of one or more quaternary ammonium surfactants to the cleaning composition enables easier rinsing of the foam. Without being bound by theory, it is believed that quaternary ammonium surfactant sterically inhibits strong surfactant packing at the air-liquid interface, thereby disfavouring strong foam stabilization and enabling better suds collapse upon rinsing.

Cleaning Composition

The cleaning composition described herein is preferably a hand dishwashing cleaning composition, preferably in liquid form. The cleaning composition is suitable for spraying with a spray dispenser.

Preferably, the pH of the composition is greater than about 8, more preferably from about 10 to about 12 and most preferably from about 10.5 to about 11.5, as measured neat at 20° C. Preferably, the composition has a reserve alkalinity of from about 0.1 to about 1, more preferably from about 0.1 to about 0.5, measured as described herein. These selected pH ranges and the reserve alkalinity ranges further contribute to the cleaning of tough food soils.

The cleaning composition disclosed herein may have a Newtonian or shear independent rheology and exhibit a viscosity of from about 1 mPa·s to about 50 mPa·s, preferably from about 1 mPa·s to about 20 mPa·s, more preferably from about 1 mPa·s to about 10 mPa·s, at 20° C., as measured using the method(s) described herein.

Alternatively, the cleaning composition disclosed herein may have a shear thinning rheology and exhibit a high shear viscosity (measured at a shear rate of 1000 s⁻¹ at 20° C.) of from about 1 mPa·s to about 50 mPa·s, preferably from about 1 mPa·s to about 20 mPa·s, more preferably from about 5 mPa·s to about 15 mPa·s, and a low shear viscosity (measured at 0.1 s⁻¹ at 20° C.) of from about 100 mPa·s to about 1,000 mPa·s, preferably from about 200 mPa·s to about 500 mPa·s, using the methods described herein. The cleaning composition preferably has a Newtonian rheology.

The liquid cleaning composition typically comprises an aqueous carrier in which all the other composition components are dissolved or eventually dispersed. As such, water can be present in an amount of from about 60% to about 95%, preferably from about 80% to about 95% by weight of the composition.

Surfactant

The cleaning composition may comprise from about 0.1% to about 15%, preferably from about 0.5% to about 10%, more preferably from about 1% to about 8% by weight of the cleaning composition of one or more surfactants. The one or more surfactants may comprise an alkyl polyglucoside surfactant, a surfactant selected from the group consisting of amphoteric surfactant, zwitterionic surfactant, and mixtures thereof, preferably an amphoteric surfactant, more preferably an amine oxide surfactant, a quaternary ammonium surfactant, and, optionally, an alkoxylated alcohol non-ionic surfactant. The alkyl polyglucoside surfactant and the surfactant selected from the group consisting of amphoteric surfactant, zwitterionic surfactant, and mixtures thereof may be present in a weight ratio of from about 10:1 to about 1:10, preferably from about 5:1 to about 1:5, more preferably from about 3:1 to about 1:1.

The cleaning composition may comprise less than about 3%, preferably less than about 2%, more preferably less than about 1% by weight of the composition of an anionic surfactant. The composition may be substantially free of or free of an anionic surfactant.

Alkyl Polyglucoside Surfactant

The composition may comprise from about 0.1% to about 5%, preferably from about 0.5% to about 4%, more preferably from about 0.8% to about 3.0% by weight of the composition of alkyl polyglucoside (“APG”).

For improved crystalline grease removal, the alkyl polyglucoside surfactant may have a number average alkyl carbon chain length of between 8 and 18, preferably between 10 and 16, more preferably between 12 and 14, with an average degree of polymerization of between about 0.1 and about 3.0, preferably between about 1.0 and about 2.0, more preferably between about 1.2 and about 1.6.

For improved initial sudsing, the alkyl polyglucoside surfactant may have a number average alkyl carbon chain length of between 8 and 18, preferably between 8 and 14, more preferably between 8 and 10, with an average degree of polymerization of between about 0.1 and about 3.0, preferably between about 1.0 and about 2.0, more preferably between about 1.2 and about 1.6.

C8-C18 alkyl polyglucosides are commercially available from several suppliers (e.g., Simusol® surfactants from Seppic Corporation; and Glucopon® 600 CSUP, Glucopon® 650 EC, Glucopon® 600 CSUP/MB, and Glucopon® 650 EC/MB, from BASF Corporation).

Amphoteric and Zwitterionic Surfactants

The cleaning composition disclosed herein may comprise a surfactant selected from the group consisting of amphoteric surfactant, zwitterionic surfactant, and mixtures thereof. The cleaning composition may comprise from about 0.1% to about 5.0%, preferably from about 0.25% to about 4.0%, more preferably from about 0.5% to about 3.0% by weight of the composition of a surfactant selected from the group consisting of amphoteric surfactant, zwitterionic surfactant, and mixtures thereof. These surfactants are found to further improve the sudsing and grease cleaning profile.

Preferably, the amphoteric surfactant is an amine oxide surfactant. The amine oxide surfactant can be linear or branched, preferably linear. Suitable linear amine oxides are typically water-soluble and are characterized by the formula R1-N(R2)(R3) 0 wherein R1 is a C8-18 alkyl, and the R2 and R3 moieties are selected from the group consisting of C1-3 alkyl groups, C1-3 hydroxyalkyl groups, and mixtures thereof. For example, R2 and R3 may be selected from the group consisting of: methyl, ethyl, propyl, isopropyl, 2-hydroxyethyl, 2-hydroxypropyl and 3-hydroxypropyl, and mixtures thereof, though methyl is preferred for one or both of R2 and R3. Suitable linear amine oxide surfactants include linear C10-C18 alkyl dimethyl amine oxides and linear C8-C12 alkoxy ethyl dihydroxy ethyl amine oxides.

Preferably, the amine oxide surfactant is selected from the group consisting of alkyl dimethyl amine oxide, alkyl amido propyl dimethyl amine oxide, and mixtures thereof. Alkyl dimethyl amine oxides, such as C8-18 alkyl dimethyl amine oxides or C10-16 alkyl dimethyl amine oxides (such as coco dimethyl amine oxide), are preferred. Suitable alkyl dimethyl amine oxides include C10 alkyl dimethyl amine oxide surfactant, C10-12 alkyl dimethyl amine oxide surfactant, C12-C14 alkyl dimethyl amine oxide surfactant, and mixtures thereof. C12-C14 alkyl dimethyl amine oxide is particularly preferred.

Alternative suitable amine oxide surfactants include mid-branched amine oxide surfactants. As used herein, “mid-branched” means that the amine oxide has one alkyl moiety having n1 carbon atoms with one alkyl branch on the alkyl moiety having n2 carbon atoms. The alkyl branch is located on the a carbon from the nitrogen on the alkyl moiety. This type of branching for the amine oxide is also known in the art as an internal amine oxide. The total sum of n1 and n2 can be from to 24 carbon atoms, preferably from 12 to 20, and more preferably from 10 to 16. The number of carbon atoms for the one alkyl moiety (n1) is preferably the same or similar to the number of carbon atoms as the one alkyl branch (n2) such that the one alkyl moiety and the one alkyl branch are symmetric. As used herein “symmetric” means that |n1−n2| is less than or equal to 5, preferably 4, most preferably from 0 to 4 carbon atoms in at least 50 wt %, more preferably at least 75 wt % to 100 wt % of the mid-branched amine oxides for use herein. The amine oxide further comprises two moieties, independently selected from a C1-3 alkyl, a C1-3 hydroxyalkyl group, or a polyethylene oxide group containing an average of from about 1 to about 3 ethylene oxide groups. Preferably, the two moieties are selected from a C1-3 alkyl, more preferably both are selected as C1 alkyl.

Alternatively, the amine oxide surfactant can be a mixture of amine oxides comprising a mixture of low-cut amine oxide and mid-cut amine oxide, for example, a mixture comprising:
a) from about 10% to about 45% by weight of the amine oxide of low-cut amine oxide of formula R1R2R3AO wherein R1 and R2 are independently selected from hydrogen, C1-C4 alkyls or mixtures thereof, and R3 is selected from C10 alkyls and mixtures thereof; and
b) from 55% to 90% by weight of the amine oxide of mid-cut amine oxide of formula R4R5R6AO wherein R4 and R5 are independently selected from hydrogen, C1-C4 alkyls or mixtures thereof, and R6 is selected from C12-C16 alkyls or mixtures thereof
   In a preferred low-cut amine oxide for use herein R3 is n-decyl, with preferably both R1 and R2 being methyl. In the mid-cut amine oxide of formula R4R5R6AO, R4 and R5 are preferably both methyl.

Preferably, the amine oxide comprises less than about 5%, more preferably less than 3%, by weight of the amine oxide of an amine oxide of formula R7R8R9AO wherein R7 and R8 are selected from hydrogen, C1-C4 alkyls and mixtures thereof and wherein R9 is selected from C8 alkyls and mixtures thereof. Limiting the amount of amine oxides of formula R7R8R9AO improves both physical stability and suds mileage.

Zwitterionic Surfactant

In compositions disclosed herein, zwitterionic surfactants may improve the removal of polymerised or “baked-on” grease. Suitable zwitterionic surfactants include betaine surfactants. Such betaine surfactants include alkyl betaines, alkylamidobetaine, amidazoliniumbetaine, sulphobetaine (INCI Sultaines), as well as the phosphobetaine, and preferably meet formula (II):

R¹—[CO—X(CH₂)ₙ]ₓ—N⁺(R²)(R³)—(CH₂)ₘ—[CH(OH)—CH₂]_{y}—Y⁻ (II)

where R¹ is a saturated or unsaturated C6-22 alkyl residue, preferably a C8-18 alkyl residue, more preferably a saturated C10-16 alkyl residue, even more preferably a saturated C12-14 alkyl residue; X is NH or NR⁴, where R4 is a C1-4 alkyl residue, 0, or S; n is an integer from 1 to 10, preferably 2 to 5, more preferably 3; x is 0 or 1, preferably 1; R2 and R3 are independently selected from C1-4 alkyl residues and hydroxy substituted (e.g., hydroxyethyl substituted) C1-4 alkyl residues, preferably both R2 and R3 are methyl groups; m is an integer from 1 to 4, preferably 1, 2 or 3; y is 0 or 1; and Y is COO, SO₃, OPO(OR⁵)O or P(O)(OR⁵)O, where R5 is H or a C1-4 alkyl residue.

Preferred betaines are the alkyl betaines of formula (IIa), the alkyl amido propyl betaine of formula (IIb), the sulphobetaines of formula (IIc) and the amido sulphobetaine of formula (IId) (R¹ is defined as described above in the context of formula (II)):

R¹—N(CH₃)₂—CH₂COO⁻ (IIa)

R¹—CO—NH—(CH₂)₃—N⁺(CH₃)₂—CH₂COO⁻ (IIb)

R¹—N⁺(CH₃)₂—CH₂CH(OH)CH₂SO₃⁻ (IIc)

R¹—CO—NH—(CH₂)₃—N⁺(CH₃)₂—CH₂CH(OH)CH₂SO₃⁻ (IId)

Particularly preferred are the carbobetaines [i.e. wherein Y—=COO— in formula (II)] of formulae (IIa) and (IIb), more preferred are the alkylamidobetaine of formula (IIb).

Suitable betaines may be selected from the group consisting of (or designated in accordance with INCI) capryl/capramidopropyl betaine, cetyl betaine, cetyl amidopropyl betaine, cocamidoethyl betaine, cocamidopropyl betaine, cocobetaines, decyl betaine, decyl amidopropyl betaine, hydrogenated tallow betaine/amidopropyl betaine, isostearamidopropyl betaine, lauramidopropyl betaine, lauryl betaine, myristyl amidopropyl betaine, myristyl betaine, oleamidopropyl betaine, oleyl betaine, palmamidopropyl betaine, palmitamidopropyl betaine, palm-kernelamidopropyl betaine, stearamidopropyl betaine, stearyl betaine, tallowamidopropyl betaine, tallow betaine, undecylenamidopropyl betaine, undecyl betaine, and mixtures thereof.

Preferred betaines are selected from the group consisting of: cocamidopropyl betaine, cocobetaines, lauramidopropyl betaine, lauryl betaine, myristyl amidopropyl betaine, myristyl betaine, and mixtures thereof. Cocamidopropyl betaine is particularly preferred.

Anionic Surfactant

The cleaning composition disclosed herein may comprise an anionic surfactant and suitable anionic surfactants include, but are not limited to, those surface-active compounds that contain an organic hydrophobic group containing generally 8 to 22 carbon atoms or generally 8 to 18 carbon atoms in their molecular structure and at least one water-solubilizing group, preferably selected from sulfonate, sulfate, and carboxylate, so as to form a water-soluble compound. Typically, the hydrophobic group will comprise a linear or branched C8-C22 alkyl or acyl group. Such surfactants are employed in the form of water-soluble salts and the salt-forming cation is generally selected from sodium, potassium, ammonium, magnesium and mono-, di- or tri-alkanolammonium, with the sodium cation being most preferred.

Preferably the compositions of the present disclosure comprise less than about 3%, preferably less than about 2%, more preferably less than about 1% by weight of the composition of an anionic surfactant. More preferably, the cleaning compositions according to the disclosure are substantially free or free of anionic surfactant.

Quaternary Ammonium Surfactant

The cleaning composition disclosed herein may comprise one or more quaternary ammonium surfactants, including mixtures of two or more different quaternary ammonium surfactants. The quaternary ammonium surfactant may be present in an amount that is effective to enable improved rinsing of the cleaning compositions. The compositions disclosed herein may contain from about 0.01% to about 5%, preferably from about 0.05% to about 3.0%, more preferably from about 0.1% to about 1.0% by weight of the composition of a quaternary ammonium surfactant.

Quaternary ammonium surfactants may have the following general formula:

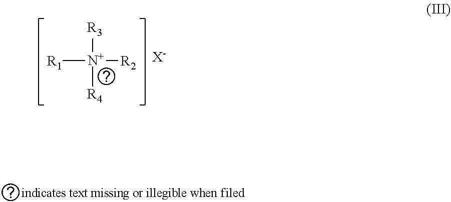

where each of the substituents R₁, R₂, R₃, and R₄ may be linear or branched, preferably linear, and each of the substituents R₁, R₂, R₃, and R₄ may independently include an amide linkage, an ether linkage, or an ester linkage. The counterion X may be any salt-forming anion, provided that the quaternary ammonium surfactant is water soluble. Exemplary counterions include halides, such as, chloride, bromide or iodide, and methosulfate. One or more of the substituents R₁, R₂, R₃, and R₄ may be independently selected from long-chain (12 or more carbon atoms) alkyl groups, long-chain (12 or more carbon atoms) alkoxyaryl groups, long-chain (12 or more carbon atoms) alkylaryl groups, halogen-substituted long-chain (12 or more carbon atoms) alkylaryl groups, long-chain (12 or more carbon atoms) alkylphenoxyalkyl groups, or long chain (12 or more carbon atoms) arylalkyl groups. One or more of the substituents R₁, R₂, R₃, and R₄ may be independently selected from hydrocarbyl groups having less than 12 carbon atoms. The quaternary ammonium group (the group in brackets in formula (III)) may have a molecular weight of at least about 165.

Suitable quaternary ammonium surfactants include quaternary ammonium surfactants characterized by the formula:

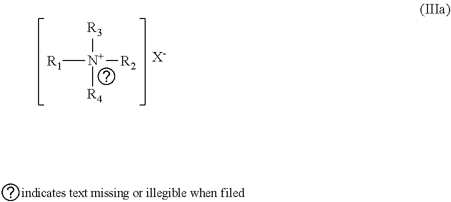

where R₁, R₂, R₃, and R₄ are independently selected from saturated or unsaturated, linear or branched hydrocarbyl groups having less than 12 carbon atoms, saturated or unsaturated, linear or branched alkyl groups having 6 to 26 carbon atoms, saturated or unsaturated, linear or branched aryl groups having 6 to 26 carbon atoms, or saturated or unsaturated, linear or branched alkylaryl groups having 6 to 26 carbon atoms, provided that at least one of R₁, R₂, R₃, and R₄ is a saturated or unsaturated, linear or branched alkyl group having 6 to 26 carbon atoms, a saturated or unsaturated, linear or branched aryl group having 6 to 26 carbon atoms, or a saturated or unsaturated, linear or branched alkylaryl group having 6 to 26 carbon atoms. Preferably, R₁ and, R₂ are independently selected from C1-C3 alkyl groups, more preferably each of R₁ and R₂ is a methyl group. Preferably, R₃ and R₄ are independently selected from C8-C18 alkyl groups, preferably C8-C12 alkyl groups, or a benzyl group. X is a salt-forming anion, preferably a halide or methosulfate, more preferably a halide, even more preferably chloride.

Preferred quaternary ammonium surfactants include quaternary ammonium surfactants characterized by the formula:

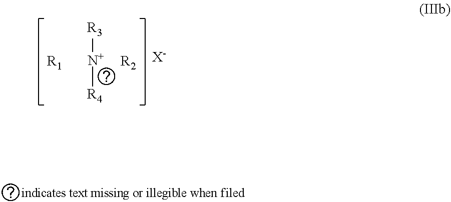

where each of R₁ and R₂ are independently selected from C1 to C3 alkyl groups, preferably each of R₁ and R₂ is a methyl group; each of R₃ and R₄ are independently selected from linear or branched (preferably linear) C8 to C18 alkyl groups, preferably linear or branched (preferably linear) C8 to C12 alkyl groups, or a benzyl group; and X is a halide, preferably chloride.

The cleaning compositions disclosed herein may contain one or more quaternary ammonium surfactants, for example, a mixture of two or more different quaternary ammonium surfactants. Non-limiting examples of useful quaternary ammonium surfactants include: (1) benzalkonium chlorides and/or substituted benzalkonium chlorides, such as commercially available Barquat® (available from Lonza), Maquat® (available from Mason), Variquat® (available from Witco/Sherex), and Hyamine® (available from Lonza); (2) di(C6-C14)alkyl di short chain (C1-4 alkyl and/or hydroxyalkl) quaternary surfactants, such as Bardac® products of Lonza, (3) N-(3-chloroallyl) hexaminium chlorides, such as Dowicide® and Dowicil® available from Dow; (4) benzethonium chloride such as Hyamine® from Rohm & Haas; (5) methylbenzethonium chloride represented by Hyamine® 10X supplied by Rohm & Haas, (6) cetylpyridinium chloride, such as Cepacol chloride available from of Merrell Labs. Examples of the suitable dialkyl quaternary compounds are dialkyl(C8-C12) dimethyl ammonium chloride, such as didecyldimethyl-ammonium chloride (Bardac 22), and dioctyldimethylammonium chloride (Bardac 2050). The quaternary ammonium surfactant may be selected from the group consisting of dialkyldimethylammonium chlorides, alkyldimethylbenzylammonium chlorides, dialkylmethylbenzylammonium chlorides, and mixtures thereof. Other suitable quaternary ammonium surfactant include diisobutylphenoxyethoxyethyl dimethylbenzylammonium chloride (commercially available under the trade name Hyamine 1622 from Rohm & Haas) and (methyl) diisobutylphenoxyethoxyethyl dimethylbenzylammonium chloride, such as methylbenzethonium chloride.

Preferably, the quaternary ammonium surfactant is selected from the group consisting of benzalkonium chloride, dialkyldimethylammonium chloride (preferably didecyldimethylammonium chloride), and mixtures thereof. More preferably, the quaternary ammonium surfactant comprises a mixture of benzalkonium chloride and didecyldimethylammonium chloride. Even more preferably, the quaternary ammonium surfactant comprises a mixture of benzalkonium chloride and didecyldimethylammonium chloride in a weight ratio of from about 5:1 to about 1:5, preferably from about 3:1 to about 1:3, more preferably from about 1.5:1 to about 1:1.5.

Alkoxylated Alcohol Non-ionic Surfactant

The cleaning composition disclosed herein may optionally comprise an alkoxylated alcohol non-ionic surfactant. The composition may comprise from about 0.5% to about 10%, preferably from about 1.0% to about 5.0%, more preferably from about 1.5% to about 3.0% by weight of the cleaning composition of an alkoxylated alcohol non-ionic surfactant. Suitable alkyl alkoxylated non-ionic surfactants include alkyl ethoxylated non-ionic surfactants. Suitable alkyl ethoxylated non-ionic surfactants include the condensation products of aliphatic alcohols with from 1 to 25 moles of ethylene oxide. The alkyl chain of the aliphatic alcohol can be linear or branched, primary or secondary. The alkyl chain of the aliphatic alcohol is preferably linear. Preferably, the alkoxylated alcohol non-ionic surfactant is a low-cut alkyl ethoxylate surfactant having an average alkyl carbon chain length of 10 or less, more preferably 5 to 8 carbon atoms, even more preferably to 7 carbon atoms. Preferably, the alkyl ethoxylate surfactant has a number average degree of ethoxylation of from 1 to 10, preferably from 3 to 8, more preferably from 4 to 6. Suitable non-ionic alcohol ethoxylate surfactants include commercially available materials, such as Emulan® HE50 or Lutensol® CS6250 (available from BASF).

Preferably, the cleaning composition comprises an alkyl polyglucoside surfactant, an amine oxide surfactant, a quaternary ammonium surfactant, and an alkyl ethoxylate surfactant (e.g., a low-cut alcohol ethoxylate surfactant as described below). More preferably the cleaning composition comprises i) from about 0.8% to about 3.0% of an alkyl polyglucoside surfactant, preferably an alkyl polyglucoside having an average alkyl chain length between 8 and 10 and an average degree of polymerization of between 1.2 and 1.6, ii) from about 1.0% to about 3.0% of an amine oxide surfactant, preferably a C12-C14 dimethyl amine oxide surfactant, iii) from about 0.1% to about 1.0% by weight of the composition of a quaternary ammonium surfactant, preferably a mixture of benzalkonium chloride and didecyldimethylammonium chloride, and iv) from about 1.5% to about 3.0% of a low cut alcohol ethoxylate non-ionic surfactant, preferably an alcohol ethoxylate non-ionic surfactant having an average alkyl chain length of between C5 and C7 and a number average degree of ethoxylation of from 4 to 6. Most preferably this composition is substantially free or free of anionic surfactant.

Organic Solvent

For improved penetration and removal of crystalline grease, the composition may comprise an organic solvent. Suitable organic solvents can be selected from the group consisting of glycol ether solvents, alcohol solvents, ester solvents, and mixtures thereof, with glycol ether solvents being preferred as they are particularly effective, when used in combination with the selected surfactants of the disclosure, to remove crystalline grease. Glycol ether solvents may also improve sudsing. The cleaning composition may comprise from about 0.1% to about 10%, preferably from about 1.0% to about 8.0%, more preferably from about 2.0% to about 7.0% by weight of the composition of an organic solvent selected from the group consisting of glycol ether, alcohol, ester, and mixtures thereof. The composition may comprise from about 0.1% to about 5.0%, more preferably from about 0.25% to about 4.5%, even more preferably from about 0.5% to about 4.0% by weight of the composition of glycol ether. The composition may comprise from about 0.1% to about 5.0%, preferably from about 0.25% to about 4.0%, more preferably from about 0.5% to about 3.0% by weight of the composition of an alcohol, preferably a C2-C4 alcohol, more preferably ethanol.

In particular, cleaning compositions having a surfactant to solvent weight ratio less than about 1:2 have been found to be less foaming and/or have been found to have a greater tendency to phase separate over time, Also, compositions having a surfactant to solvent weight ratio greater than about 5:1 are typically more difficult to spray and may be more prone to gelling, when sprayed onto greasy soils that have not been pre-wetted. Such gel formation may inhibit the spreading of the composition onto the greasy surface and lead to less satisfactory cleaning. The compositions disclosed herein preferably have a weight ratio of surfactant to solvent ranging from about 1:2 to about 5:1, preferably from about 1:2 to about 4:1, preferably from about 1:1 to about 3:1. These selected weight ratios of surfactant to solvent have been found to provide improved coverage on the dishware with minimum over-spray (residual spray droplets remaining in suspension in the air). Therefore, such spray compositions reduce waste and minimise the amount of spray droplets which can be inhaled.

Suitable glycol ether solvents can be selected from the group consisting of:
a) Formula I: R1O(R2O)nR3,
   R1 is a linear or branched C4, C5 or C6 alkyl or a substituted or unsubstituted phenyl, R2 is ethyl or isopropyl, R3 is hydrogen or methyl and n is 1, 2 or 3;
b) Formula II: R4O(R5O)nR6,
   R4 is n-propyl or isopropyl, R5 is isopropyl, R6 is hydrogen or methyl and n is 1, 2 or 3; and
c) mixtures thereof

Suitable alcohol solvents can be selected from the group consisting of: C4-C6 linear mono-alcohols, branched C4-C10 mono-alcohols having one or more C1-C4 branching groups, alkyl mono-glycerols, and mixtures thereof

Suitable ester solvents can be selected from the group consisting of glycol ethers of:
a) monoesters having the formula R1C═OOR2,
   wherein R1 is a linear or branched C1 to C4 alkyl, and R2 is a linear or branched C2 to C8 alkyl;
b) di- or tri-esters having the formula R1(C═00R2)n,
   R1 is a saturated or unsaturated C2 to C4 alkyl, R2 is independently selected from a linear or branched C2 to C8 alkyl, and n is 2 or 3;
c) benzylbenzoate; and
d) mixtures thereof.

The composition comprises from 0.1% to 10%, preferably from 1.0% to 8.0%, more preferably from 3.0% to 7.0% by weight of the total composition of the organic solvent.

The surfactant system and the organic solvent can be in a weight ratio of from 5:1 to 1:2, preferably from 4:1 to 1:2, most preferably 3:1 to 1:1.

Suitable glycol ether solvents can be selected from glycol ethers of Formula I, Formula II, and mixtures thereof:
a) Formula I=R1O(R2O)nR3
wherein
R1 is a linear or branched C4, C5 or C6 alkyl, a substituted or unsubstituted phenyl, preferably n-butyl. Benzyl is one of the substituted phenyls for use herein.
R2 is ethyl or isopropyl, preferably isopropyl
R3 is hydrogen or methyl, preferably hydrogen
n is 1, 2 or 3, preferably 1 or 2
b) Formula II=R4O(R5O)nR6
wherein
R4 is n-propyl or isopropyl, preferably n-propyl
R5 is isopropyl
R6 is hydrogen or methyl, preferably hydrogen
n is 1, 2 or 3 preferably 1 or 2

Suitable glycol ether solvents according to Formula I include ethyleneglycol n-butyl ether, diethyleneglycol n-butyl ether, triethyleneglycol n-butyl ether, propyleneglycol n-butyl ether, dipropyleneglycol n-butyl ether, tripropyleneglycol n-butyl ether, ethyleneglycol n-pentyl ether, diethyleneglycol n-pentyl ether, triethyleneglycol n-pentyl ether, propyleneglycol n-pentyl ether, dipropyleneglycol n-pentyl ether, tripropyleneglycol n-pentyl ether, ethyleneglycol n-hexyl ether, diethyleneglycol n-hexyl ether, triethyleneglycol n-hexyl ether, propyleneglycol n-hexyl ether, dipropyleneglycol n-hexyl ether, tripropyleneglycol n-hexyl ether, ethyleneglycol phenyl ether, diethyleneglycol phenyl ether, triethyleneglycol phenyl ether, propyleneglycol phenyl ether, dipropyleneglycol phenyl ether, tripropyleneglycol phenyl ether, ethyleneglycol benzyl ether, diethyleneglycol benzyl ether, triethyleneglycol benzyl ether, propyleneglycol benzyl ether, dipropyleneglycol benzyl ether, tripropyleneglycol benzyl ether, ethyleneglycol isobutyl ether, diethyleneglycol isobutyl ether, triethyleneglycol isobutyl ether, propyleneglycol isobutyl ether, dipropyleneglycol isobutyl ether, tripropyleneglycol isobutyl ether, ethyleneglycol isopentyl ether, diethyleneglycol isopentyl ether, triethyleneglycol isopentyl ether, propyleneglycol isopentyl ether, dipropyleneglycol isopentyl ether, tripropyleneglycol isopentyl ether, ethyleneglycol isohexyl ether, diethyleneglycol isohexyl ether, triethyleneglycol isohexyl ether, propyleneglycol isohexyl ether, dipropyleneglycol isohexyl ether, tripropyleneglycol isohexyl ether, ethyleneglycol n-butyl methyl ether, diethyleneglycol n-butyl methyl ether triethyleneglycol n-butyl methyl ether, propyleneglycol n-butyl methyl ether, dipropyleneglycol n-butyl methyl ether, tripropyleneglycol n-butyl methyl ether, ethyleneglycol n-pentyl methyl ether, diethyleneglycol n-pentyl methyl ether, triethyleneglycol n-pentyl methyl ether, propyleneglycol n-pentyl methyl ether, dipropyleneglycol n-pentyl methyl ether, tripropyleneglycol n-pentyl methyl ether, ethyleneglycol n-hexyl methyl ether, diethyleneglycol n-hexyl methyl ether, triethyleneglycol n-hexyl methyl ether, propyleneglycol n-hexyl methyl ether, dipropyleneglycol n-hexyl methyl ether, tripropyleneglycol n-hexyl methyl ether, ethyleneglycol phenyl methyl ether, diethyleneglycol phenyl methyl ether, triethyleneglycol phenyl methyl ether, propyleneglycol phenyl methyl ether, dipropyleneglycol phenyl methyl ether, tripropyleneglycol phenyl methyl ether, ethyleneglycol benzyl methyl ether, diethyleneglycol benzyl methyl ether, triethyleneglycol benzyl methyl ether, propyleneglycol benzyl methyl ether, dipropyleneglycol benzyl methyl ether, tripropyleneglycol benzyl methyl ether, ethyleneglycol isobutyl methyl ether, diethyleneglycol isobutyl methyl ether, triethyleneglycol isobutyl methyl ether, propyleneglycol isobutyl methyl ether, dipropyleneglycol isobutyl methyl ether, tripropyleneglycol isobutyl methyl ether, ethyleneglycol isopentyl methyl ether, diethyleneglycol isopentyl methyl ether, triethyleneglycol isopentyl methyl ether, propyleneglycol isopentyl methyl ether, dipropyleneglycol isopentyl methyl ether, tripropyleneglycol isopentyl methyl ether, ethyleneglycol isohexyl methyl ether, diethyleneglycol isohexyl methyl ether, triethyleneglycol isohexyl methyl ether, propyleneglycol isohexyl methyl ether, dipropyleneglycol isohexyl methyl ether, tripropyleneglycol isohexyl methyl ether, and mixtures thereof.

Preferred glycol ether solvents according to Formula I are ethyleneglycol n-butyl ether, diethyleneglycol n-butyl ether, triethyleneglycol n-butyl ether, propyleneglycol n-butyl ether, dipropyleneglycol n-butyl ether, tripropyleneglycol n-butyl ether, and mixtures thereof.

The most preferred glycol ether solvents according to Formula I are propyleneglycol n-butyl ether, dipropyleneglycol n-butyl ether, and mixtures thereof.

Suitable glycol ether solvents according to Formula II include propyleneglycol n-propyl ether, dipropyleneglycol n-propyl ether, tripropyleneglycol n-propyl ether, propyleneglycol isopropyl ether, dipropyleneglycol isopropyl ether, tripropyleneglycol isopropyl ether, propyleneglycol n-propyl methyl ether, dipropyleneglycol n-propyl methyl ether, tripropyleneglycol n-propyl methyl ether, propyleneglycol isopropyl methyl ether, dipropyleneglycol isopropyl methyl ether, tripropyleneglycol isopropyl methyl ether, and mixtures thereof.

Preferred glycol ether solvents according to Formula II are propyleneglycol n-propyl ether, dipropyleneglycol n-propyl ether, and mixtures thereof.

The most preferred glycol ether solvents are propyleneglycol n-butyl ether, dipropyleneglycol n-butyl ether, and mixtures thereof, especially dipropyleneglycol n-butyl ether.

Suitable glycol ether solvents can be purchased from The Dow Chemical Company, in particularly from the E-series (ethylene glycol based) Glycol Ether and the P-series (propylene glycol based) Glycol Ether line-ups. Suitable glycol ether solvents include Butyl Carbitol, Hexyl Carbitol, Butyl Cellosolve, Hexyl Cellosolve, Butoxytriglycol, Dowanol Eph, Dowanol PnP, Dowanol DPnP, Dowanol PnB, Dowanol DPnB, Dowanol TPnB, Dowanol PPh, and mixtures thereof.

Suitable alcohols can be selected from the group consisting of C4-C6 linear mono-alcohols, branched C4-C10 mono-alcohols having one or more C1-C4 branching groups, alkyl mono-glycerols, and mixtures thereof.

Preferred C4-C6 linear mono-alcohols are selected from pentanol, hexanol, and mixtures thereof, preferably 1-pentanol, 1-hexanol, and mixtures thereof.

Preferred branched C4-C10 mono-alcohols having one or more C1-C4 branching groups for use herein are C4-C8 primary mono-alcohols having one or more C1-C4 branching groups, and mixtures thereof. Especially preferred branched C4-C10 mono-alcohols having one or more C1-C4 branching groups for use herein include methyl butanol, ethyl butanol, methyl pentanol, ethyl pentanol, methyl hexanol, ethyl hexanol, propyl hexanol, dimethyl hexanol trimethyl hexanol, methyl hepanol, ethyl heptanol, propyl heptanol, dimethyl heptanol, trimethyl heptanol, methyl octanol, ethyl octanol, propyl octanol, butyl octanol, dimethyl octanol, trimethyl octanol, methyl nonanol, ethyl nonanol, propyl nonanol, butyl nonanol, dimethyl nonanol and trimethyl nonanol, and mixtures thereof. More preferred for use herein are the primary 1-alcohol member of branched C4-C10 mono-alcohols having one or more C1-C4 branching groups, especially preferred are the primary 1-alcohol family members of methyl butanol, ethyl butanol, methyl pentanol, ethyl pentanol, methyl hexanol, ethyl hexanol, propyl hexanol, dimethyl hexanol trimethyl hexanol, methyl hepanol, ethyl heptanol, propyl heptanol, dimethyl heptanol, trimethyl heptanol, methyl octanol, ethyl octanol, propyl octanol, butyl octanol, dimethyl octanol, trimethyl octanol, methyl nonanol, ethyl nonanol, propyl nonanol, butyl nonanol, dimethyl nonanol, trimethyl nonanol, and mixtures thereof.

More preferred alcohols are butyl octanol, trimethyl hexanol, ethyl hexanol, propyl heptanol, methyl butanol, and mixtures thereof, in particular the primary 1-alcohol family member, more in particular ethyl hexanol, butyl octanol, trimethyl hexanol, and mixtures thereof, especially 2-ethyl-1-hexanol, 2-butyl-1-octanol, 3,5,5 trimethyl-1-hexanol, and mixtures thereof.

Preferred alkyl mono-glycerols are selected from the group consisting of branched alkyl mono-glycerols and mixtures thereof, more preferably branched C4-C8 alkyl mono-glycerols with one or more C1 to C4 alkyl branching groups, more preferably selected from the group consisting of ethylhexylglycerol, propylheptylglycerol, and mixtures thereof, most preferably 2-ethylhexylglycerol.

Such alcohols can also improve sudsing.

Especially preferred for use herein are mixtures of mono-alcohols, in particular mixtures comprising a branched C4-C10 mono-alcohol, more in particular mixtures comprising an alcohol selected from the group comprising C4-C8 more preferably C6-C7 branched primary alcohols. Preferably for use is a mixture of alcohols comprising an alcohol selected from the group comprising C4-C8 branched primary alcohols with an alcohol selected of the group of C4-C6 linear mono-alcohols and alkylglycerols. Such mixtures can boost foaming and improve cleaning of various oily soils.

Suitable ester solvents can be selected from the group consisting of monoester solvents of Formula III, di- or triester solvents of formula IV, benzylbenzoate, and mixtures thereof
a) Monoester solvents of formula III: R1C═00R2, wherein:
   R1 is a linear of branched C1 to C4 alkyl, preferably a linear or branched C2 to C3 alkyl;
   R2 is a linear or branched C2 to C8 alkyl, preferably a linear or branched C2 to C6 alkyl, most preferably a linear of branched C3 to C4 alkyl;
b) Di- or triester solvents of formula IV: R1(C═00R2)n, wherein:
   R1 is a saturated or unsaturated C2 to C4 alkyl;
   R2 is independently selected from a linear or branched C2 to C8 alkyl, preferably a linear or branched C2 to C6 alkyl, most preferably a linear of branched C3 to C4 alkyl;
   n is 2 or 3 preferably 2;

Suitable monoester solvents of formula III include but are not limited to ethylacetate, propylacetate, isopropylacetate, butylacetate, isobutylacetate, amylacetate, isoamylacetate, hexylacetate, isohexylacetate, heptylacetate, isoheptylacetate, octylacetate, isooctylacetate, 2-ethylhexylacetate, ethylpropionate, propylpropionate, isopropylpropionate, butylpropionate, isobutylpropionate, amylpropionate, isoamylpropionate, hexylpropionate, isohexylpropionate, heptylpropionate, isoheptylpropionate, octylpropionate, isooctylpropionate, 2-ethylhexylpropionate, ethylbutyrate, propylbutyrate, isopropylbutyrate, butylbutyrate, isobutylbutyrate, amylbutyrate, isoamylbutyrate, hexylbutyrate, isohexylbutyrate, heptylbutyrate, isoheptylbutyrate, octylbutyrate, isooctylbutyrate, 2-ethylhexylbutyrate, ethylisobutyrate, propylisobutyrate, isopropylisobutyrate, butylisobutyrate, isobutylisobutyrate, amylisobutyrate, isoamylisobutyrate, hexylisobutyrate, isohexylisobutyrate, heptylisobutyrate, isoheptylisobutyrate, octylisobutyrate, isooctylisobutyrate, 2-ethylhexylisobutyrate, ethylpentanoate, propylpentanoate, isopropylpentanoate, butylpentanoate, isobutylpentanoate, amylpentanoate, isoamylpentanoate, hexylpentanoate, isohexylpentanoate, heptylpentanoate, isoheptylpentanoate, octylpentanoate, isooctylpentanoate, 2-ethylhexylpentanoate, ethylisopentanoate, propylisopentanoate, isopropylisopentanoate, butylisopentanoate, isobutylisopentanoate, amylisopentanoate, isoamylisopentanoate, hexylisopentanoate, isohexylisopentanoate, heptylisopentanoate, isoheptylisopentanoate, octylisopentanoate, isooctylisopentanoate, 2-ethylhexylisopentanoate, and mixtures thereof.

Preferred monoester solvents of formula III can be selected from the group consisting of ethylpropionate, propylpropionate, isopropylpropionate, butylpropionate, isobutylpropionate, amylpropionate, isoamylpropionate, hexylpropionate, isohexylpropionate, ethylbutyrate, propylbutyrate, isopropylbutyrate, butylbutyrate, isobutylbutyrate, amylbutyrate, isoamylbutyrate, hexylbutyrate, isohexylbutyrate, ethylisobutyrate, propylisobutyrate, isopropylisobutyrate, butylisobutyrate, isobutylisobutyrate, amylisobutyrate, isoamylisobutyrate, hexylisobutyrate, isohexylisobutyrate, and mixtures thereof.

Most preferably, the monoester solvents are selected from the group consisting of propylpropionate, isopropylpropionate, butylpropionate, isobutylpropionate, propylbutyrate, isopropylbutyrate, butylbutyrate, isobutylbutyrate, propylisobutyrate, isopropylisobutyrate, butylisobutyrate, isobutylisobutyrate, and mixtures thereof.

Suitable di- or tri-ester solvents of formula IV can be selected from: ethyl-, propyl-, isopropyl-, butyl-, isobutyl-, amyl-, isoamyl-, hexyl-, isohexyl-, heptyl-, isoheptyl, octyl-, isooctyl-, 2-ethylhexy- di- or tri-esters of succinic acid, glutaric acid, adipic acid, maleic acid, fumaric acid, glutaconic acid, citric acid, aconitic acid, propane-1,2,3-tricarboxylic acid, and mixtures thereof.

Preferred di- or tri-ester solvents are selected from the group consisting of ethyl-, propyl-, isopropyl-, butyl-, isobutyl-, amyl-, isoamyl-, hexyl-, isohexyl- di- or tri-esters of succinic acid, glutaric acid, adipic acid, maleic acid, fumaric acid, glutaconic acid, citric acid, aconitic acid, propane-1,2,3-tricarboxylic acid, and mixtures thereof.

More preferably, the di- or tri-ester solvents are selected from the group consisting of ethyl-, propyl-, isopropyl-, butyl-, isobutyl- di- or tri-esters of succinic acid, glutaric acid, adipic acid, maleic acid, fumaric acid, glutaconic acid, citric acid, aconitic acid, propane-1,2,3-tricarboxylic acid, and mixtures thereof.

Additional Optional Ingredients

Chelant: The composition herein may optionally further comprise a chelant at a level of from 0.1% to 10%, preferably from 0.2% to 5%, more preferably from 0.2% to 3%, most preferably from 0.5% to 1.5% by weight of the composition.

Suitable chelating agents can be selected from the group consisting of amino carboxylates, amino phosphonates, polyfunctionally-substituted aromatic chelating agents and mixtures thereof.

Amino carboxylates include ethylenediaminetetra-acetates, N-hydroxyethylethylenediaminetriacetates, nitrilo-triacetates, ethylenediamine tetraproprionates, triethylenetetraaminehexacetates, diethylenetriaminepentaacetates, and ethanoldiglycines, alkali metal, ammonium, and substituted ammonium salts therein and mixtures therein, as well as MGDA (methyl-glycine-diacetic acid), and salts and derivatives thereof and GLDA (glutamic-N,N-diacetic acid) and salts and derivatives thereof. GLDA (salts and derivatives thereof) is especially preferred according to the invention, with the tetrasodium salt thereof being especially preferred.

Builder: The composition herein may comprise a builder, preferably a carboxylate builder. Salts of carboxylic acids useful herein include salts of C1-6 linear or at least 3 carbon containing cyclic acids. The linear or cyclic carbon-containing chain of the carboxylic acid or salt thereof may be substituted with a substituent group selected from the group consisting of hydroxyl, ester, ether, aliphatic groups having from 1 to 6, more preferably 1 to 4 carbon atoms, and mixtures thereof.

Preferred salts of carboxylic acids are those selected from the salts from the group consisting of salicylic acid, maleic acid, acetyl salicylic acid, 3 methyl salicylic acid, 4 hydroxy isophthalic acid, dihydroxyfumaric acid, 1,2,4 benzene tricarboxylic acid, pentanoic acid, citric acid, and mixtures thereof, preferably citric acid.

Alternative carboxylate builders suitable for use in the composition of the invention includes salts of fatty acids like palm kernel derived fatty acids or coconut derived fatty acid, or salts of polycarboxylic acids.

The cation of the salt is preferably selected from alkali metal, alkaline earth metal, monoethanolamine, diethanolamine or triethanolamine and mixtures thereof, preferably sodium.

The carboxylic acid or salt thereof, when present, is preferably present at the level of from 0.01% to 5%, more preferably from 0.03% to 1% by weight of the total composition.

Hydrotropes: The composition according to the disclosure may further comprise a hydrotrope. Preferably the hydrotrope is selected from cumene sulphonate, xylene sulphonate, toluene sulphonate, most preferably sodium neutralized cumene sulphonate. When present the hydrotrope is formulated from 0.1% to 5%, preferably from 0.25% to 3%, most preferably from 0.5% to 2% by weight of the cleaning composition.

Shear thinning rheology modifier: The composition according to the disclosure may further comprise a rheology modifying agent, providing a shear thinning rheology profile to the product. Formulating with a rheology modifying polymer can improve particle size distribution of the resultant spray, as well as mitigating any stinging effect of the spray droplets. Preferably the rheology modifying agent is a non crystalline polymeric rheology modifier. This polymeric rheology modifier can be a synthetic or a naturally derived polymer.

Examples of naturally derived polymeric structurants of use in the present invention include: hydroxyethyl cellulose, hydrophobically modified hydroxyethyl cellulose, carboxymethyl cellulose, polysaccharide derivatives and mixtures thereof. Polysaccharide derivatives include but are not limited to pectine, alginate, arabinogalactan (gum Arabic), carrageenan, gum karaya, gum tragacanth, gellan gum, xanthan gum and guar gum. Examples of synthetic polymeric structurants of use in the present invention include polymers and copolymers comprising polycarboxylates, polyacrylates, polyurethanes, polyvinylpyrrolidone, polyols and derivatives and mixtures thereof. Alternatively the composition of use in the invention can comprise a polyethylenoxide (PEO) polymer.

Preferably the composition according to the invention comprises a rheology modifying polymer selected from a naturally derived rheology modifying polymer, most preferably Xanthan Gum, a polyethylenoxide, or mixtures thereof.

Generally, the rheology modifying polymer will be comprised at a level of from 0.001% to 1% by weight, alternatively from 0.01% to 0.5% by weight, more alternatively from 0.05% to 0.25% by weight of the composition.

Other ingredients: The composition herein may comprise a number of optional ingredients, such as rheology trimming agents selected from inorganic salts preferably sodium chloride, C2-C4 alcohols, C2-C4 polyols, poly alkylene glycols and especially polypropyleneglycols having a weight average molecular weight of from 1500 to 4,000, and mixtures thereof.

The compositions of the present invention can comprise a cleaning amine, such as a cyclic cleaning amine. The term “cyclic diamine” herein encompasses a single cleaning amine and a mixture thereof. The amine can be subjected to protonation depending on the pH of the cleaning medium in which it is used. Especially preferred for use herein are cyclic diamines selected from the group consisting of 1, 3-bis(methylamine)-cyclohexane, 2-methylcyclohexane-1,3-diamine, 4-methylcyclohexane-1,3-diamine and mixtures thereof 1, 3-bis(methylamine)-cyclohexane is especially preferred for use herein. Mixtures of 2-methylcyclohexane-1,3-diamine, 4-methylcyclohexane-1,3-diamine are also preferred for use herein.

The composition might also comprise pH trimming and/or buffering agents such as sodium hydroxide, alkanolamines including monoethanolamine, and carbonate/bicarbonate inorganic salts. The composition might comprise further minor ingredients selected from preservatives, UV stabilizers, antioxidants, perfumes, coloring agents and mixtures thereof.

Spray Dispenser

The spray dispenser comprises a reservoir to accommodate the composition of the invention and spraying means. Suitable spray dispensers include hand pump (sometimes referred to as “trigger”) devices, pressurized can devices, electrostatic spray devices, etc. Preferably the spray dispenser is non-pressurized and the spray means are of the trigger dispensing type. The reservoir is typically a container such as a bottle, more typically a plastic bottle.

The cleaning product of the invention includes the cleaning composition. The cleaning composition is typically suitable for spraying from the spray dispenser onto the dish surface to be treated (“direct application”). The composition preferably forms a foam on the surface immediately upon application without requiring any additional physical (e.g., manual rubbing) intervention.

The spray dispenser typically comprises a trigger lever which, once depressed, activates a small pump. The main moving element of the pump is typically a piston, housed inside a cylinder, with the piston pressing against a spring. By depressing the trigger, the piston is pushed into the cylinder and against the spring, compressing the spring, and forcing the composition contained within the pump out of a nozzle. Once the trigger lever is released, the spring pushes the piston back out, expanding the cylinder area, and sucking the composition from the reservoir, typically through a one-way valve, and refilling the pump. This pump is typically attached to a tube that draws the composition from the reservoir into the pump. The spray dispenser can comprise a further one-way valve, situated between the pump and the nozzle.

The nozzle comprises an orifice through which the composition is dispensed. The nozzle utilises the kinetic energy of the composition to break it up into droplets as it passes through the orifice. Suitable nozzles can be plain, or shaped, or comprise a swirl chamber immediately before the orifice. Such swirl chambers induce a rotary fluid motion to the composition which causes swirling of the composition in the swirl chamber. A film is discharged from the perimeter of the orifice which typically results in dispensing the composition from the orifice as finer droplets.

Since such trigger-activated spray dispensers comprise a pump, the composition preferably is not pressurized within the reservoir and preferably does not comprise a propellant.

The spray dispenser can be a pre-compression sprayer which comprises a pressurized buffer for the composition, and a pressure-activated one-way valve between the buffer and the spray nozzle. Such precompression sprayers provide a more uniform spray distribution and more uniform spray droplet size since the composition is sprayed at a more uniform pressure. Such pre-compression sprayers include the Flairosol® spray dispenser, manufactured and sold by Afa Dispensing Group (The Netherlands) and the pre-compression trigger sprayers described in U.S. Patent Publication Nos. 2013/0112766 and 2012/0048959.

Method of Use

The cleaning products, as described herein, are particularly suited for methods of cleaning dishware comprising the steps of: optionally pre-wetting the dishware; spraying the cleaning composition onto the dishware; optionally scrubbing the dishware; and rinsing the dishware.

The cleaning products described herein are particularly effective at loosening soils, especially greasy soils. As such, especially for light soiling, a scrubbing step is optional, particularly when the composition is left on the dishware for at least 15 seconds, preferably at least seconds, after spraying and before rinsing.

The steps of scrubbing of the dishware and rinsing the dishware can take place at least partially simultaneously, for example, by scrubbing the dishware under running water or when the dishware is submerged in water. The scrubbing step can take between 1 second and 30 seconds.

The present method allows for faster and easier cleaning of dishware when the dishware is lightly soiled. When the dishware is heavily soiled with tough food soils such as cooked-, baked- or burnt-on soils, the present method facilitates the cleaning when the soiled dishware is soaked with the product of the invention in neat form or diluted in water, preferably for a period of from 1 second to 30 seconds, or longer.

### Methods

A) Reserve Alkalinity:

Reserve alkalinity is defined as the grams of NaOH per 100 g of composition required to titrate the test composition at pH 10 to come to the test composition pH. The reserve alkalinity for a solution is determined in the following manner.

A pH meter (for example An Orion Model 720A) with a Ag/AgCl electrode (for example an Orion sure flow Electrode model 9172BN) is calibrated using standardized pH 7 and pH 10 buffers. A 100 g of a 10% solution in distilled water at 20° C. of the composition to be tested is prepared. The pH of the 10% solution is measured and the 100 g solution is titrated down to pH 10 using a standardized solution of 0.1 N of HCl. The volume of 0.1N HCl required is recorded in ml. The reserve alkalinity is calculated as follows:

Reserve Alkalinity=ml 0.1N HCl×0.1 (equivalent/liter)×Equivalent weight NaOH (g/equivalent)×10

B) Viscosity:

The rheology profile is measured using a “TA instruments DHR1” rheometer, using a cone and plate geometry with a flat steel Peltier plate and a 60 mm diameter, 2.026° cone (TA instruments, serial number: SN960912). The viscosity measurement procedure includes a conditioning step and a sweep step at 20° C. The conditioning step consists of a 10 seconds at zero shear at 20° C., followed by pre-shearing for 10 seconds at 10 s⁻¹ at 20° C., followed by 30 seconds at zero shear at 20° C. in order for the sample to equilibrate. The sweep step comprises a logarithmical shear rate increase in log steps starting from 0.01 s⁻¹ to 3,000 s⁻¹ at 20° C., with a 10 points per decade acquisition rate taken in a sample period of 15 s, after a maximum equilibration time of 200 seconds (determined by the rheometer, based on a set tolerance of 3%). When measuring shear thinning product compositions, the high shear viscosity is defined at a shear rate of 1,000 s⁻¹, and the low shear viscosity at a shear rate of 0.1 s⁻¹. For Newtonian product compositions the shear rate is recorded at 1,000 s⁻¹.

C) Rinsing Efficacy:

Spraying: Test formulations are sprayed once into a 50 ml graduated Falcon test tube, the spraying direction being alongside the length of the Falcon test tube, and the amount of foam generated is weighed. Each test product is sprayed in a separate Falcon test tube. 10 ml of rinse water (demineralized water at 20° C.) is added gently through a syringe along the sidewall of the vertically held Falcon test tube at the 50 ml height mark. The liquid fraction is then decanted gently in order not to destroy the foam structure.

Rinsing: 5 ml of rinse water (demineralized water at 20° C.) is added gently through a syringe to each Falcon test tube along the sidewall of the vertically held Falcon test tube at the 50 ml height mark. All test tubes are shaken manually simultaneously ten times vertically up and down over a distance of 20 cm at a speed of 2 up and down cycles per second, after which each Falcon test tube is maintained in a static upright position for 30 seconds to equilibrate, before measuring the remaining foam volume. The liquid fraction is then decanted gently in order not to destroy the foam structure. This rinsing step is repeated until there is no foam left in the tube.

The test is repeated five times and the average remaining foam volume is reported for each test formulation in accordance with the number of rinsing cycles completed.

### Examples

The rinsing efficacy of liquid cleaning spray formulations according to the present disclosure (Examples 1 to 3), which comprise C8-C10 alkyl polyglucoside, C12-C14 dimethylamine oxide, benzalkonium chloride (Lonzagard BKC c-GMP), and didecyldimethylammonium chloride (Uniquat 2250), and the rinsing efficacy of a comparative liquid cleaning spray formulation (Example A), which differs from Examples 1 to 3 in that it lacks the quaternary ammonium surfactants benzalkonium chloride and didecyldimethylammonium chloride, are assessed. Examples 2 and 3 comprise a single quaternary ammonium surfactant, while Example 1 comprises two different quaternary ammonium surfactants. The compositions are prepared by mixing the individual components in a batch type system.

TABLE 1

| % on 100% active basis | Ex A | Ex 1 | Ex 2 | Ex 3 |
|---|---|---|---|---|
| C8 to C10 APG (Glucopon 215) | 1.00 | 1.00 | 1.00 | 1.00 |
| C1214 dimethylamine oxide | 1.50 | 1.50 | 1.50 | 1.50 |
| C6EO5 nonionic surfactant | 2.50 | 2.50 | 2.50 | 2.50 |
| (Lutensol CS6250) | | | | |
| Monoethanolamine | 0.50 | 0.50 | 0.50 | 0.50 |
| GLDA chelant | 1.00 | 1.00 | 1.00 | 1.00 |
| PPG (MW 2000) | 0.05 | 0.05 | 0.05 | 0.05 |
| Ethanol | 2.00 | 2.00 | 2.00 | 2.00 |
| glycol ether (Dowanol DPnB) | 1.70 | 1.70 | 1.70 | 1.70 |
| Phenoxyethanol (Dowanol EPH) | 0.60 | 0.60 | 0.60 | 0.60 |
| Benzalkoniumchloride (Lonzagard | — | 0.10 | 0.10 | — |
| BKC c-GMP) | | | | |
| Didecyldimethylamoniumchloride | — | 0.25 | — | 0.25 |
| (Uniquat 2250) | | | | |
| Perfume | 0.25 | 0.25 | 0.25 | 0.25 |
| Water | Balance | Balance | Balance | Balance |
| | to 100 | to 100 | to 100 | to 100 |
| pH (neat - NaOH or HCl trim) | 11.0 | 11.0 | 11.0 | 11.0 |

All of the compositions are tested using the same spray dispenser, available from the AFA company, under the Flairosol® tradename.

TABLE 2

| Rinsing | A | 1 | 2 | 3 |
|---|---|---|---|---|
| Cycle | (mL of | (mL of | (mL of | (mL of |
| Number | foam) | foam) | foam) | foam) |
| 0 | 19.5 | 16 | 17.5 | 19.5 |
| 1 | 43 | 21.5 | 30.5 | 43.5 |
| 2 | 41 | 14.5 | 20.5 | 42 |
| 3 | 40.5 | 0 | 2.5 | 33.5 |
| 4 | 38 | | 0 | 18 |
| 5 | 31.5 | | | 4.5 |
| 6 | 10.5 | | | 0 |
| 7 | 0 | | | |

The data in Table 2 show that the foam generated by Examples 1 to 3, which comprise quaternary ammonium surfactant, is suppressed in fewer rinse cycles as compared to the foam generated by comparative Example A, which lacks quaternary ammonium surfactant. Therefore, Examples 1 to 3 demonstrate improved rinsing performance, as compared to Example A. The data also shows that the dual quaternary ammonium surfactant system of Example 1 demonstrates improved rinsing performance as compared to Examples 2 and 3, each of which comprises a single quaternary ammonium surfactant.

Further illustrative example formulations according to the disclosure are shown in Table 3 below.

TABLE 3

| % on 100% active basis | Ex 4 | Ex 5 | Ex 6 | Ex 7 |
|---|---|---|---|---|
| C8 to C10 APG (Glucopon 215) | 1.50 | 1.00 | 1.50 | 2.00 |
| C1214 dimethylamine oxide | 1.00 | 2.00 | 2.00 | 1.00 |
| C6EO5 nonionic surfactant | 2.50 | 3.00 | 2.00 | 2.00 |
| (Lutensol CS6250) | | | | |
| Monoethanolamine | 0.50 | 0.75 | 0.30 | 0.50 |
| GLDA chelant | 1.25 | 0.75 | 1.00 | 1.00 |
| PPG (MW 2000) | 0.05 | 0.10 | — | 0.05 |
| ethanol | 2.00 | 0.7 | 0.7 | 1.00 |
| glycol ether (Dowanol DPnB) | 2.50 | 1.70 | 2.50 | 1.00 |
| Phenoxyethanol (Dowanol EPH) | 0.60 | 0.50 | 0.75 | 0.60 |
| Citric acid | — | 0.01 | 0.04 | 0.03 |
| Benzalkoniumchloride (Lonzagard | 0.15 | 0.20 | 0.25 | 0.10 |
| BKC c-GMP) | | | | |
| Didecyldimethylamoniumchloride | 0.20 | 0.15 | 0.10 | 0.10 |
| (Uniquat 2250) | | | | |
| perfume | 0.25 | 0.25 | 0.25 | 0.20 |
| water | Balance | Balance | Balance | Balance |
| | to 100 | to 100 | to 100 | to 100 |
| pH (neat - NaOH or HCl trim) | 11.0 | 11.5 | 10.5 | 11.0 |

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A cleaning product comprising a spray dispenser and a cleaning composition housed in the spray dispenser, the cleaning composition comprising from 0.1% to 15% by weight of the composition, of one or more surfactants comprising:
i. an alkyl polyglucoside,
ii. a surfactant selected from the group consisting of amphoteric surfactants, zwitterionic surfactants, and mixtures thereof, and
iii. a quaternary ammonium surfactant,
wherein the alkyl polyglucoside and the surfactant selected from group consisting of amphoteric surfactants, zwitterionic surfactants, and mixtures thereof are present in a weight ratio of from 10:1 to 1:10 and wherein the cleaning composition comprises less than 3%, by weight of the cleaning composition, of anionic surfactant.

2. The cleaning product according to claim 1, wherein the cleaning composition comprises from 0.1% to 5%, by weight of the composition, of alkyl polyglucoside.

3. The cleaning product according to claim 1, wherein the cleaning composition comprises from 0.5% to 4.0%, by weight of the composition, of alkyl polyglucoside.

4. The cleaning product according to claim 1, wherein the cleaning composition comprises from 0.8% to 3.0%, by weight of the composition, of alkyl polyglucoside.

5. The cleaning product according to claim 1, wherein the cleaning composition comprises from 0.1% to 5%, by weight of the composition, of a surfactant selected from the group consisting of amphoteric surfactants, zwitterionic surfactants, and mixtures thereof.

6. The cleaning product according to claim 1, wherein the cleaning composition further comprises an amphoteric surfactant.

7. The cleaning product according to claim 1, wherein the cleaning composition comprises a zwitterionic surfactant.

8. The cleaning product according to claim 1, wherein the alkyl polyglucoside and the surfactant selected from group consisting of amphoteric surfactants, zwitterionic surfactants, and mixtures thereof are present at a weight ratio of from 5:1 to 1:5.

9. The cleaning product according to claim 1, wherein the cleaning composition further comprises an alkoxylated alcohol non-ionic surfactant.

10. The cleaning product according to claim 9, wherein the alkoxylated alcohol non-ionic surfactant is an alkyl ethoxylate surfactant.

11. The cleaning product according to claim 1, wherein the cleaning composition is substantially free of anionic surfactant.

12. The cleaning product according to claim 1, wherein the cleaning composition comprises from 0.01% to 5%, by weight of the composition, of the quaternary ammonium surfactant.

13. The cleaning product according to claim 1, wherein the quaternary ammonium surfactant has the formula: 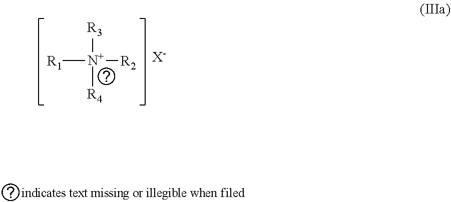
wherein R₁, R₂, R₃, and R₄ are independently selected from saturated or unsaturated, linear or branched hydrocarbyl groups having less than 12 carbon atoms, saturated or unsaturated, linear or branched alkyl groups having 6 to 26 carbon atoms, saturated or unsaturated, linear or branched aryl groups having 6 to 26 carbon atoms, or saturated or unsaturated, linear or branched alkylaryl group having 6 to 26 carbon atoms, provided that at least one of R₁, R₂, R₃, or R₄ is a saturated or unsaturated, linear or branched alkyl group having 6 to 26 carbon atoms, a saturated or unsaturated, linear or branched aryl group having 6 to 26 carbon atoms, or a saturated or unsaturated, linear or branched alkylaryl group having 6 to 26 carbon atoms.

14. The cleaning product according to claim 13, wherein the quaternary ammonium surfactant is selected from the group consisting of benzalkonium chloride, dialkyldimethylammonium chloride, didecyldimethylammonium chloride, and mixtures thereof.

15. The cleaning product according to claim 1, wherein the cleaning composition comprises from 0.1% to 10%, by weight of the composition, of an organic solvent selected from the group consisting of glycol ether, alcohol, ester, and mixtures thereof.

16. The cleaning product according to claim 15, wherein the cleaning composition comprises from 0.1% to 5.0% by weight of the composition, of glycol ether.

17. The cleaning product according to claim 15, wherein the cleaning composition comprises from 0.1% to 5.0%, by weight of the composition, of alcohol.
